(19) United States
(12) Patent Application Publication
(10) Pub. No.: US 2023/0347932 A1
(43) Pub. Date: Nov. 2, 2023

(54) EVALUATION OF COMPONENTS OF AUTONOMOUS VEHICLES BASED ON DRIVING RECOMMENDATIONS

(71) Applicant: Perceptive Automata, Inc., Boston, MA (US)

(72) Inventors: Jeffrey Donald Zaremba, Cambridge, MA (US); Chuan Yen Ian Goh, Lincoln, MA (US); Omar Al Assad, Milton, MA (US); Till S. Hartman, Brookline, MA (US); Sonia Poltoraski, Norfolk, MA (US); Samuel English Anthony, Sommerville, CA (US); James Gowers, Sunnyvale, CA (US)

(21) Appl. No.: 18/308,634

(22) Filed: Apr. 27, 2023

Related U.S. Application Data
(60) Provisional application No. 63/336,184, filed on Apr. 28, 2022.
(60) Provisional application No. 63/336,185, filed on Apr. 28, 2022.

(51) Int. Cl. B60W 60/00; G05B 13/02; G08G 1/01; B60W 40/06; B60W 40/12

(52) U.S. Cl. CPC B60W 60/001; G05B 13/0265; G08G 1/0125; B60W 40/06; B60W 40/12; B60W 2552/00

(57) ABSTRACT

A system evaluates modifications to components of an autonomous vehicle (AV) stack. The system receives driving recommendations traffic scenarios based on user annotations of video frames showing each traffic scenario. For each traffic scenario, the system predicts driving recommendations based on the AV stack. The system determines a measure of quality of driving recommendation by comparing predicted driving recommendations based on the AV stack with the driving recommendations received for the traffic scenario. The measure of quality of driving recommendation is used for evaluating components of the AV stack. The system determines a driving recommendation for an AV corresponding to ranges of SOMAI (state of mind) score and sends signals to controls of the autonomous vehicle to navigate the autonomous vehicle according to the driving recommendation. The system identifies additional training data for training machine learning model based on the measure of driving quality.

### CROSS-REFERENCE TO RELATED APPLICATIONS

This application claims the benefit of U.S. Provisional Application No. 63/336,184 filed Apr. 28, 2022, and U.S. Provisional Application No. 63/336,185 filed Apr. 28, 2022, each of which is incorporated by reference in its entirety.

### TECHNICAL FIELD

The present disclosure relates in general generally to autonomous vehicles and more specifically to evaluation of components of autonomous vehicles based on driving recommendations.

### BACKGROUND

Autonomous vehicles use various techniques to evaluate their surroundings so that the autonomous vehicle can be navigated through the traffic. An autonomous vehicle uses sensors to sense the traffic and uses various techniques including machine learning based models to determine how various traffic entities such as motors, pedestrians, cyclists, and others are behaving and interacting. The autonomous vehicle sends control signals to the controls of the autonomous vehicles to navigate through the traffic based on these determinations. However due to the complex nature of the problem, the driving of an autonomous vehicle is not as smooth as the driving of a human driver. For example, the autonomous vehicle may stop too far in advance compared to a typical human driver when it notices a pedestrian in a crosswalk; the autonomous vehicle may drive too slowly compared to a typical human driver when the pedestrian has crossed the street; the autonomous vehicle may break suddenly compared to a typical human driver; or the autonomous vehicle may stop in situations where a typical human driver may not consider any need to stop. Accordingly, autonomous driving behavior can be jarring, surprising, or not human-like. Artificial intelligence techniques such as machine learning based models are used for making predictions used for navigating autonomous vehicles through traffic. Due to the large number of factors that determine driving decisions made when a vehicle is driving through traffic, it is difficult to train and evaluate such machine learning based models.

### SUMMARY

A system evaluates modifications to components of an autonomous vehicle stack. The system receives driving recommendations for a set of traffic scenarios determined based on user annotations of video frames showing each traffic scenario. For each traffic scenario, the system predicts driving recommendations based on the autonomous vehicle stack. The system determines a measure M1 of quality of driving recommendation by comparing predicted driving recommendations based on the autonomous vehicle stack with the driving recommendations received for the traffic scenario. The system receives a modified component corresponding to a component of the autonomous vehicle stack. For each of the set of traffic scenarios, the system predicts driving recommendations based on the autonomous vehicle stack including the modified component. The system determines M2, a measure of quality of driving recommendation by comparing predicted driving recommendations based on the autonomous vehicle stack including the modified component with the driving recommendations received for the traffic scenario. The system evaluates the modified component based on a comparison of the measures M1 and M2.

A system according to an embodiment, accesses a machine learning based model trained to receive an input video frame showing a traffic entity and output a score describing the traffic entity in the input video frame. The system stores a mapping from ranges of values of the score to driving recommendations for a plurality of traffic scenarios. Each driving recommendation for a traffic scenario is determined based on annotations provided by users presented with a video frame representing the traffic scenario. The system receives a video frame captured by a camera mounted on an autonomous vehicle at a particular time while driving. The system identifies a traffic scenario corresponding to the particular video frame. The system accesses the mapping from the ranges of values of the score to driving recommendations corresponding to the particular traffic scenario. The system apples the machine learning based model to the particular video frame to output a score describing a traffic entity in the particular video frame. The system identifies a range of scores corresponding to the score describing the traffic entity in the particular video frame that was output by the machine learning based model. The system determines a driving recommendation for the autonomous vehicle corresponding to the range of score and sends signals to controls of the autonomous vehicle to navigate the autonomous vehicle according to the driving recommendation.

The system according to an embodiment, sends a set S1 of video frames to a set of users. Each video frame shows a traffic scenario including one or more traffic entities. The system receives a set of annotations based on video frames of the set S1 of video frames. Each annotation of the set of annotations is for a video frame from the set S1 of video frames and describes a state of mind of a traffic entity shown in the video frame. The system trains a machine learning based model using the set of annotations of the set S1 of video frames. The machine learning based model is configured to receive an input video frame and predict a state of mind of a traffic entity displayed in the video frame.

The system sends another set S2 of video frames to a set of users, each video frame of S2 showing a traffic scenario comprising one or more traffic entities. The system receives annotations based on video frames of the set S2 of video frames. Each annotation is for a video frame from the set S2 of video frames and describes a driving recommendation for the traffic scenario shown in the video frame being annotated. The system determines a measure of driving quality of an autonomous vehicle based on a comparison of driving actions determined based on predictions of the machine learning based model and driving recommendations received from annotators. The system identifies additional training data for training the machine learning based model based on the measure of driving quality. The system trains the machine learning based model based on the additional training data.

### BRIEF DESCRIPTION OF FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1A is a system diagram of a networked system for predicting human behavior nd learning to respond appropriately according to some embodiments of the invention.

FIG. 1B is the system architecture of a vehicle computing system that navigates an autonomous vehicle based on prediction of hidden context associated with traffic objects according to an embodiment of the invention.

FIG. 2 is the architecture of a driving recommendation system according to an embodiment of the invention.

FIG. 3 is a system diagram showing a sensor system associated with a vehicle, according to some embodiments of the invention.

FIG. 4A illustrates the data structures for making driving recommendations for various scenarios, according to some embodiments of the invention.

FIG. 4B shows a mapping from state of mind signals to driving recommendations, according to some embodiments of the invention.

FIG. 4C shows an example user interface presented to expert annotators to receive their driving recommendations, according to some embodiments of the invention.

FIG. 5 illustrates the flow of data for making driving recommendations, according to some embodiments of the invention.

FIG. 6 illustrates the process for evaluating a machine learning based model used by an autonomous vehicle, according to some embodiments of the invention.

FIG. 7 shows the data flow of a process for evaluating a component of an autonomous vehicle, according to some embodiments of the invention.

FIG. 8 is a flowchart generating driving recommendations for use as ground truth for component evaluation, according to some embodiments of the invention.

FIG. 9 is a flowchart of a process for using driving recommendations for evaluating components of an autonomous vehicle, according to some embodiments of the invention.

FIG. 10 is a flowchart of a process for using driving recommendations as ground truth for evaluating modifications to components of an autonomous vehicle, according to some embodiments of the invention.

FIG. 11 is a flowchart showing a process of training a machine learning based model using summary statistics, according to some embodiments.

FIG. 12 is a flowchart showing a process of evaluating the machine learning based models for predicting the state of mind of road users using a trained learning algorithm, according to some embodiments.

FIG. 13 is a block diagram illustrating components of an example machine able to read instructions from a machine-readable medium and execute them in a processor (or controller).

### DETAILED DESCRIPTION

Embodiments analyze sensor data captured by sensors of an autonomous vehicle to make driving recommendations for navigating the autonomous vehicle through traffic. The system stores mappings from traffic scenarios to driving recommendations as ground truth table. The system uses the ground truth table to evaluate components of an AV stack. For example, the system may identify traffic scenarios where the AV stack performs well and traffic scenarios where the AV stack performance is poor. The system may compare different AV stacks using the driving recommendations, for example, an AV stacks with additional component, an AV stack with fewer component, or AV stack with modified component, for example an AV stack with a newer release of a component.

According to an embodiment, an autonomous vehicle receives sensor data from sensors mounted on the autonomous vehicle. Traffic entities from the traffic are identified based on the sensor data. For each of traffic entity, a hidden context is determined based on a machine learning based model. The machine learning based model is trained based on feedback received from users presented with images or videos showing traffic scenarios. The output of the machine learning based model comprises a measure of statistical distribution of the hidden context.

In one embodiment, the machine learning based model is trained as follows. The system generates stimuli comprising a plurality of video frames representing traffic entities. The stimulus comprises sample images of traffic entities near streets and/or vehicles and indicate or are measured for their understanding of how they believe the people will behave. The stimulus is modified to indicate a turn direction that a vehicle is planning on turning into. For example, the images of the stimuli may include arrows representing the turn direction. Alternatively, the stimuli may be annotated with text information describing the turn direction. The system presents the stimuli to a group of users (or human observers). These indicators or measurements are then used as a component for training a machine learning based model that predicts how people will behave in a real-world context. The machine learning based model is trained based on the reactions of human observers to sample images in a training environment. The trained machine learning based model predicts behavior of traffic entities in a real-world environment, for example, actual pedestrian or bicyclist behavior in traffic as a vehicle navigates through the traffic.

In an embodiment, the autonomous vehicle is navigated by generating signals for controlling the autonomous vehicle based on the motion parameters and the hidden context of each of the traffic entities. The generated signals are sent to controls of the autonomous vehicle. The sensor data may represent images or videos captured by cameras mounted on the autonomous vehicle or lidar scans captured by a lidar mounted on the autonomous vehicle.

Systems for predicting human interactions with vehicles are disclosed in U.S. patent application Ser. No. 15/830,549, filed on Dec. 4, 2017 which is incorporated herein by reference in its entirety. Systems for controlling autonomous vehicles based on machine learning based models are described in U.S. patent application Ser. No. 16/777,386, filed on Jan. 30, 2020, U.S. patent application Ser. No. 16/777,673, filed on Jan. 30, 2020, and U.S. patent application Ser. No. 16/709,788, filed on Jan. 30, 2020, and PCT Patent Application Number PCT/US2020/015889 filed on Jan. 30, 2020, each of which is incorporated herein by reference in its entirety.

### System Environment

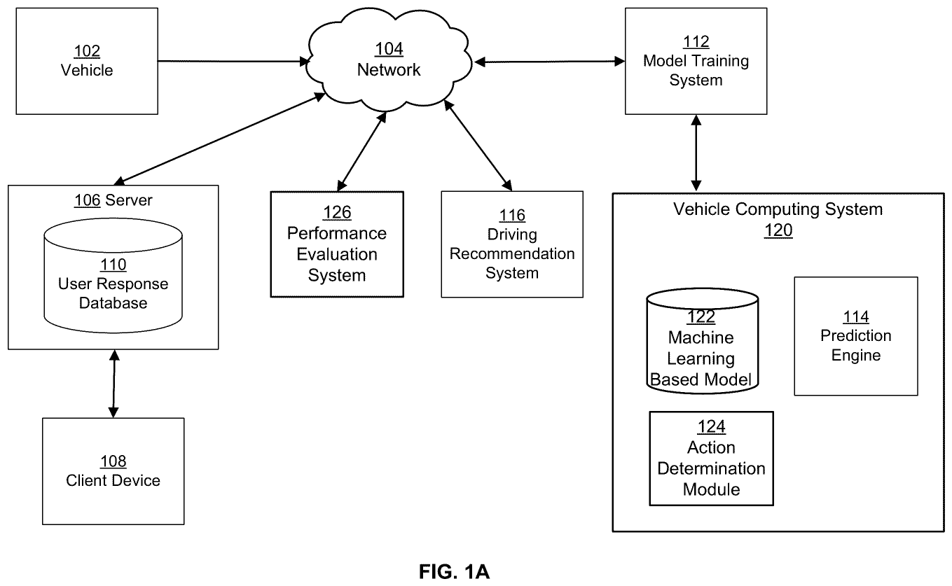

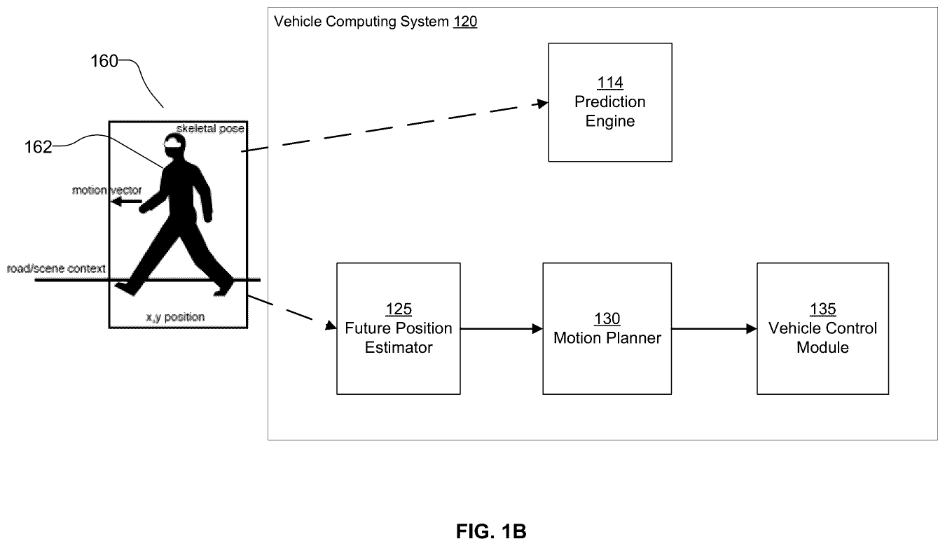

FIG. 1A is a system diagram of a networked system for predicting human behavior according to some embodiments of the invention. FIG. 1A shows a vehicle 102, a network 104, a server 106, a user response database 110, a client device 108, a model training system 112, a vehicle computing system 120, a performance evaluation system 126, and a driving recommendation system 116. The vehicle computing system 120 includes a machine learning based model 122 that is trained by the model training system 112 and an action determination module 124.

The vehicle 102 can be any type of manual or motorized vehicle such as a car, bus, train, scooter, or bicycle. In an embodiment, the vehicle 102 is an autonomous vehicle. As described in more detail below, the vehicle 102 can include sensors for monitoring the environment surrounding the vehicle. In one implementation, the sensors can include a camera affixed to any portion of the vehicle for capturing a video of people near the vehicle.

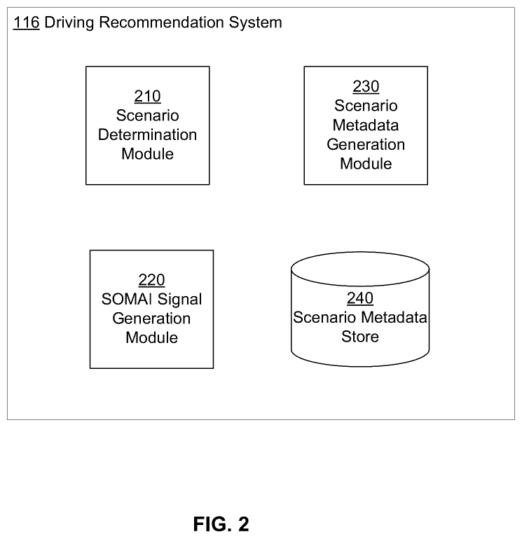

The driving recommendation system 116 makes driving recommendations while navigating the autonomous vehicle through traffic. The details of training driving recommendation system 116 are further described in connection with FIG. 2.

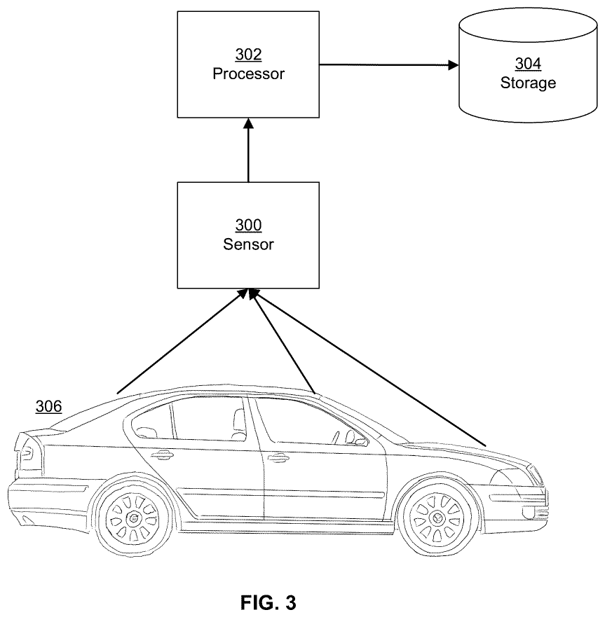

The performance evaluation system 126 compares driving actions determined by the machine learning based model 122 to driving actions of humans to evaluate driving quality of the vehicle. The driving actions of humans that are used as ground truth for driving actions are determined by aggregating feedback from human annotators. Common measures for determining driving quality of autonomous vehicles include disengagements, how predicted trajectory of vehicles and traffic entities compared to actual trajectory, and ride comfort. However, these measures do not capture how well model-based vehicle driving behavior conforms to expectations of good driving. In contrast, by comparing driving actions recommended by human annotators to driving actions determined using the machine learning model 122, a degree to which the model-based driving deviates from driving actions performed by a human can be quantified. The deviation can then be used to improve training of the machine learning based model 122, identify specific scenarios in which the deviation is greater than a threshold, adjust thresholds for determining driving actions, or other useful applications to improve driving quality of the vehicle. The process for evaluating the machine learning based model 122 is described with respect to FIG. 3.

The vehicle computing system 120 can be implemented in any computing system. In an illustrative example, the vehicle computing system 120 stores the trained machine learning based model 122 and the action determination module 124 applies the trained machine learning based model 122 to determine driving actions for a vehicle based on video frames captured while the vehicle is traveling. The machine learning based model 122 is configured to output one or more values representing state of mind of traffic entities in the video frames. The values may represent attributes such as intention of traffic entities to perform an action or level of awareness that the traffic entities have of the vehicle. The output values indicate how the traffic entities in the vehicle's environment are likely to behave, and driving actions for the vehicle is determined given the predicted behaviors of the traffic entities.

In some embodiments, driving actions may be determined by comparing values output by the machine learning based model 122 to ranges of values associated with driving actions that a vehicle can make. Examples of driving actions that can be selected include driving, stopping, and slowing down. Each of the driving actions may be associated with a different range of values, and a driving action is selected when the associated range of values includes the value output by the machine learning based model 122. For example, when the machine learning based model 122 outputs a value for mean intent of a pedestrian captured in a video segment, the action determination module 124 may select “drive” when the output value is 0.0≤x<0.4, “slow down” when the output value is 0.4≤x<0.6, and “stop” when the output value is 0.6≤x<1. The range of values used for driving action determination may be determined by determining bounds on expected overly aggressive and overly conservative behavior. For example, the bounds may be 95% confidence that the range of values will lead to less than 5% overly aggressive behavior for the vehicle and 95% confidence that that range of values will lead to less than 10% of overly conservative behavior. Depending on how many attributes are predicted by the machine learning based model 122, the driving action may be determined from a multi-dimensional driving action table. For example, a first value output by the machine learning based model 122 may be mean intent, and a second value output by the machine learning based model 122 may be mean awareness.

In some embodiments, the range of values may be tuned based on a target behavior of the vehicle (e.g., aggressive, conservative). A user of the vehicle may select the target behavior based on their location (e.g., if the vehicle is in a city vs. suburbs), based on their confidence in other types of sensors, or preferences. In some embodiments, the target behavior may be tuned by the user in the vehicle in real-time as the vehicle is traveling.

In some embodiments, the range of values associated with the driving actions may vary depending on the scenario in the video frame. The relevant scenario for a given video frame may be identified in real-time using map semantic information and/or information associated with traffic entities in the video frame (e.g., positions of the traffic entities relative to the vehicle, types of traffic entities present, number of traffic entities present). Map semantic information may include characteristics of a location such as a type of intersection (e.g., 3-way stop vs. 4-way stop), number of lanes on the road, whether there is a bike lane, whether the location is in a city or suburbs, or other information that may be relevant for identifying a scenario.

In some embodiments, the action determination module 124 determines path predictions of traffic entities and/or motion planner of the vehicle in addition to the outputs of the machine learning based model 122 to determine the driving actions.

The performance evaluation system 126 compares driving actions determined by the machine learning based model 122 to driving actions of humans to evaluate driving quality of the vehicle. The driving actions of humans that are used as ground truth for driving actions are determined by aggregating feedback from human annotators. Common measures for determining driving quality of autonomous vehicles include disengagements, how predicted trajectory of vehicles and traffic entities compared to actual trajectory, and ride comfort. However, these measures do not capture how well model-based vehicle driving behavior conforms to expectations of good driving. In contrast, by comparing driving actions recommended by human annotators to driving actions determined using the machine learning model 122, a degree to which the model-based driving deviates from driving actions performed by a human can be quantified. The deviation can then be used to improve training of the machine learning based model 122, identify specific scenarios in which the deviation is greater than a threshold, adjust thresholds for determining driving actions, or other useful applications to improve driving quality of the vehicle. The process for evaluating the machine learning based model 122 is described herein.

The network 104 can be any wired and/or wireless network capable of receiving sensor data collected by the vehicle 102 and distributing it to the server 106, the model training system 112, and, through the model training system 112, the prediction engine 114.

The server 106 can be any type of computer system capable of (1) hosting information (such as image, video and text information) and delivering it to a user terminal (such as client device 108), (2) recording responses of multiple users (or human observers) to the information, and (3) delivering such information and accompanying responses (such as responses input via client device 108) back to the network 104.

The user response database 110 can be any type of database or data storage system capable of storing the image, video, and text information and associated user responses and subsequently recalling them in response to a query.

The model training system 112 trains a machine learning based model configured to predict hidden context attributes of traffic entities. The model training system 112 can be implemented in any type of computing system. In one embodiment, the system 112 receives the image, video, and/or text information and accompanying, or linked, user responses from the database 110 over the network 104. The model training system 112 can use images, video segments and text segments as training examples to train an algorithm, and can create labels from the accompanying user responses based on the trained algorithm. These labels indicate how the algorithm predicts the behavior of the people in the associated image, video, and/or text segments. After the labels are created, the model training system 112 can transmit them to a prediction engine 114 that executes the trained model.

The prediction engine 114 may be implemented in any computing system. In an illustrative example, the prediction engine 114 includes process that executes a machine learning based model that has been trained by the model training system 112. This process estimates a label for a new (e.g., an actual “real-world”) image, video, and/or text segment based on the labels and associated image, video, and/or text segments that it received from the model training system 112. In some embodiments, this label comprises aggregate or summary information about the responses of a large number of users (or human observers) presented with similar image, video, or text segments while the algorithm was being trained.

FIG. 1B is the system architecture of a vehicle computing system that navigates an autonomous vehicle based on prediction of hidden context associated with traffic objects according to an embodiment of the invention. The vehicle computing system 120 comprises the prediction engine 114, a future position estimator 125, a motion planner 130, a vehicle control module 135. Other embodiments may include more or fewer modules than those shown in FIG. 1B. Actions performed by a particular module as indicated herein may be performed by other modules than those indicated herein.

The sensors of an autonomous vehicle capture sensor data 160 representing a scene describing the traffic surrounding the autonomous vehicle. Examples of sensors used by an autonomous vehicle include cameras, lidars, GNSS (global navigation satellite system such as a global positioning system, or GPS), IMU (inertial measurement unit), and so on. Examples of sensor data includes camera images and lidar scans.

The traffic includes one or more traffic entities, for example, a pedestrian 162. The vehicle computing system 120 analyzes the sensor data 160 and identifies various traffic entities in the scene, for example, pedestrians, bicyclists, other vehicles, and so on. The vehicle computing system 120 determines various parameters associated with the traffic entity, for example, the location (represented as x and y coordinates), a motion vector describing the movement of the traffic entity, and so on. For example, a vehicle computing system 120 may collect data of a person's current and past movements, determine a motion vector of the person at a current time based on these movements, and extrapolate a future motion vector representing the person's predicted motion at a future time based on the current motion vector.

The future position estimator 125 estimates the future position of a traffic entity. The motion planner 130 determines a plan for the motion of the autonomous vehicle. The vehicle control module 135 sends signals to the vehicle controls (for example, accelerator, brakes, steering, emergency braking system, and so on) to control the movement of the autonomous vehicle. In an embodiment, the future position estimates for a traffic entity determined by the future position estimator 125 based on sensor data 160 are provided as input to the motion planner 130. The motion planner 130 determines a plan for navigating the autonomous vehicle through traffic and provides a description of the plan to the vehicle control module 135. The vehicle control module 135 generates signals for providing to the vehicle controls. For example, the vehicle control module 135 may send control signals to an emergency braking system to stop the vehicle suddenly while driving, the vehicle control module 135 may send control signals to the accelerator to increase or decrease the speed of the vehicle, or the vehicle control module 135 may send control signals to the steering of the autonomous vehicle to change the direction in which the autonomous vehicle is moving.

FIG. 2 is the architecture of a driving recommendation system 116 according to an embodiment. The training data generation system 116 comprises a scenario determination module 210, a SOMAI signal generation module 220, a scenario metadata generation module 230, and a scenario metadata store 240. Other embodiments may include more or fewer modules that those indicated in FIG. 2.

The scenario determination module 210 identifies a particular traffic scenario from the sensor data received by a vehicle. A scenario has a scenario type that represents the type of scenario. Examples of types of scenarios include a pedestrian waiting on the side of the street, a pedestrian entering a crosswalk, a pedestrian in the crosswalk, a pedestrian entering a crosswalk while the vehicle is turning right, and so on.

In an embodiment, the system receives a filter (or a filtering criteria) based on various attributes including following. (1) Vehicle attributes such as speed, turn direction, and so on. Vehicle attribute values are obtained from equipment such as on-board diagnostics (OBD), inertial measurement unit (IMU), or a navigation system, for example, a global navigation satellite system (GNSS) such as a global positioning system (GPS). For example, the vehicle may obtain speed of the vehicle from the IMU, location of the vehicle from GPS, and vehicle diagnostic information from OBD. (2) Traffic attributes describing behavior of traffic entities, for example, whether a pedestrian has intent to cross the street, what is the location of the traffic entity with respect to the road, for example, whether the traffic entity is a pedestrian standing on the side of the street, whether the traffic entity is a pedestrian crossing the street, and so on. (3) Road attributes, for example, whether there is an intersection or a crosswalk coming up. The road attribute may be extracted from a mapping service based on a current location of the autonomous vehicle, for example, based on GPS or the road attribute may be extracted from the video frame. For example, a cross walk may be detected in the video frame to determine a road attribute value indicating a cross walk is approaching, or a traffic intersection light may be detected in the video frame indicating that a traffic intersection is approaching. The road attribute may indicate that a traffic sign that causes the speed of the autonomous vehicle to change is approaching, for example, based on a detection of the traffic sign in the video frame by an object detection technique. Examples of such traffic signs include, a stop sign, a traffic sign indicating a particular speed zone, a sign indicating a lane merge, and so on.

The system applies the filter to video frames to identify sets of video frames representing different scenarios. In an embodiment, each filtering criterion is specified as an expression comprising sub-expressions, each subexpression representing a predicate based on a value or sets of values or ranges of values of a particular attribute, for example, a predicate evaluating to true if the value of the particular attribute for the input video frame is within a specific range (or belongs to a predefined set of values), and false otherwise, or a predicate evaluating to true if the value of the particular attribute for the input video frame is equal to a specific value, and false otherwise.

In an embodiment, a filtering criterion is represented as an expression of attributes, for example a boolean expression comprising AND or OR operators combining individual criterion. The expression of attributes comprises subexpressions, each subexpression specifying value or values for an attribute. For example, a road attribute RA1 may have value 1 if there is a crosswalk within a threshold distance of the autonomous vehicle and 0 otherwise; an vehicle attribute VA1 may represent the speed of the vehicle; a traffic attribute TA1 may have value 1 if a pedestrian is crossing the street in front of the autonomous vehicle and 0 if the pedestrian decides not to cross the street. A filtering criterion may be represented as the expression (RA1=1 AND VA1=0 and TA1=1) represents traffic scenarios in which the autonomous vehicle is stopped (speed is zero) and there is a crosswalk ahead of the autonomous vehicle and there is a pedestrian crossing the street. The filtering criterion (RA1=1 AND VA1=0 and TA1=0) represents traffic scenarios in which the autonomous vehicle is stopped (speed is zero) and there is a crosswalk ahead of the autonomous vehicle and there is a pedestrian standing on the side of the street but not crossing.

The SOMAI signal generation module 220 receives the sensor data from the sensors of a vehicle and invokes the prediction engine to predict the SOMAI signal, for example, the state of mind of a traffic entity (e.g., a pedestrian or bicyclist) by executing the machine learning based models disclosed herein, for example, the machine learning based models trained by the model training system 112. The details of the machine learning based models used for determining SOMAI signals are described in detail herein.

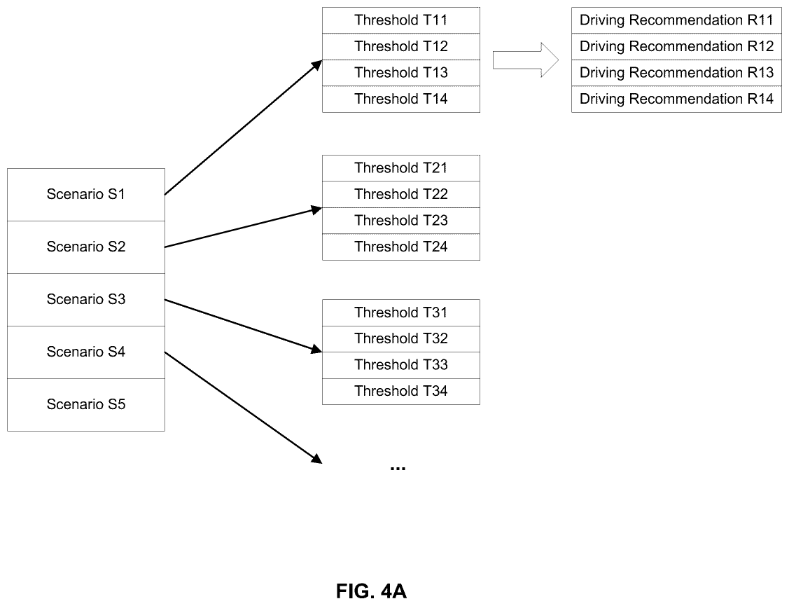

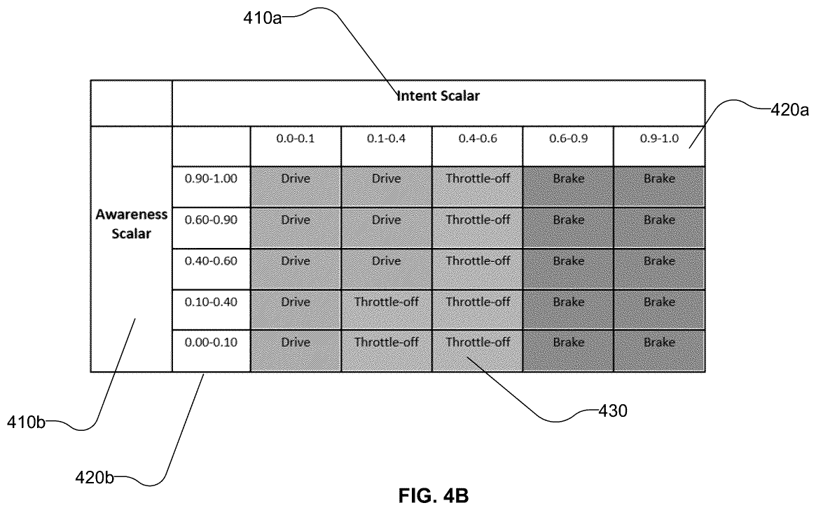

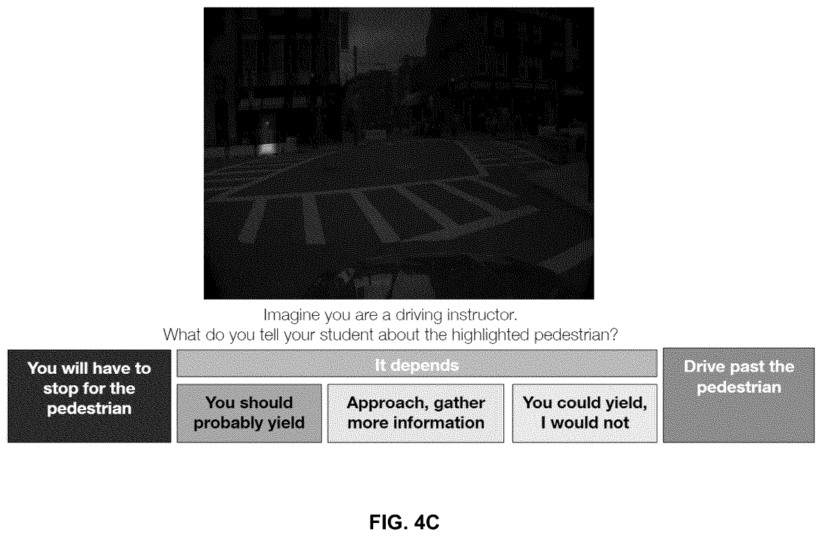

The scenario metadata generation module 230 determines various threshold values for making driving recommendations for various scenarios. The details of the mappings generated by the scenario metadata generation module 230 are described herein, for example, in FIGS. 4A and 4B. The scenario metadata generated by the scenario metadata generation module 230 is stored in the scenario metadata store 240. In an embodiment, the scenario metadata store 240 is a relational database that stores the mappings as relations or tables. However, other embodiments may implement the scenario metadata store 240 using other types of datastores, for example, as a file store.

FIG. 3 is a system diagram showing a sensor system associated with a vehicle, according to some embodiments of the invention. FIG. 3 shows a vehicle 306 with arrows pointing to the locations of its sensors 300, a local processor 302, and remote storage 304.

Data is collected from cameras or other sensors 300 including solid state Lidar, rotating Lidar, medium range radar, or others mounted on the car in either a fixed or temporary capacity and oriented such that they capture images of the road ahead, behind, and/or to the side of the car. In some embodiments, the sensor data is recorded on a physical storage medium (not shown) such as a compact flash drive, hard drive, solid state drive or dedicated data logger. In some embodiments, the sensors 300 and storage media are managed by the processor 302.

The sensor data can be transferred from the in-car data storage medium and processor 302 to another storage medium of remote storage 304 which could include cloud-based, desktop, or hosted server storage products. In some embodiments, the sensor data can be stored as video, video segments, or video frames.

In some embodiments, data in the remote storage 304 also includes database tables associated with the sensor data. When sensor data is received, a row can be added to a database table that records information about the sensor data that was recorded, including where it was recorded, by whom, on what date, how long the segment is, where the physical files can be found either on the internet or on local storage, what the resolution of the sensor data is, what type of sensor it was recorded on, the position of the sensor, and other characteristics.

In an embodiment, the system trains a machine learning based model to predict information describing traffic entities. The system receives sensor data captured at various locations. In one implementation, the sensor data represents video or other data captured by a camera or sensor mounted on the vehicle 102. The camera or other sensor can be mounted in a fixed or temporary manner to the vehicle 102. The camera does not need to be mounted to an automobile, and could be mounted to another type of vehicle, such as a bicycle or a motorcycle. Furthermore, embodiments disclosed herein are also applicable to mobile robotic systems such as sidewalk delivery robots. As the vehicle travels along various streets, the camera or sensor captures still and/or moving images (or other sensor data) of pedestrians, bicycles, automobiles, etc. moving or being stationary on or near the streets. The sensor data captured by the camera or other sensor may be transmitted from the vehicle 102, over the network 104, and to the server 106 where it is stored.

The system extracts sensor data captured at locations determined to have high likelihood of finding vehicles of a particular vehicle type (e.g., bicycles) in traffic as well as any other types of road users such as pedestrians. The system trains the machine learning based model using the extracted sensor data. In an embodiment, the sensor data may be labelled, for example, by users presented with the sensor data. The users viewing the sensor data may annotate the sensor data with information. For example, the users may annotate the sensor data with information describing the state of mind of a user identified in the sensor data such as a pedestrian or bicyclist. The system uses the annotations of the sensor data to label the data and use the labelled data to train the machine learning based model, for example, using a supervised learning technique. In an embodiment, the machine learning based model is configured to receive as input, sensor data and predict an output representing state of mind of a user captured by the sensor data. The state of mind as predicted using the machine learning based model is also referred to as the SOMAI (state of mind artificial intelligence) signal.

The prediction engine 114 uses the trained model from the model training system 112 to apply 408 the trained model to other sensor data to generate a [symbol] prediction of user behavior associated with the [symbol] other video data. The prediction engine 114 may predict the actual, “real-world” or “live data” behavior of people on or near a road. In one embodiment, the prediction engine 114 receives “live data” that matches the format of the data used to train the trained model. For example, if the trained model was trained based on video data received from a camera on the vehicle 102, the “live data” that is input to the algorithm likewise is video data from the same or similar type camera. On the other hand, if the model was trained based on another type of sensor data received from another type of sensor on the vehicle 102, the “live data” that is input to the prediction engine 114 likewise is the other type of data from the same or similar sensor.

The trained model or algorithm makes a prediction of what a pedestrian or other person shown in the “live data” would do based on the summary statistics and/or training labels of one or more derived stimulus. The accuracy of the model is determined by having it make predictions of novel derived stimuli that were not part of the training images previously mentioned but which do have human ratings attached to them, such that the summary statistics on the novel images can be generated using the same method as was used to generate the summary statistics for the training data, but where the correlation between summary statistics and image data was not part of the model training process. The predictions produced by the trained model comprise a set of predictions of the state of mind of road users that can then be used to improve the performance of autonomous vehicles, robots, virtual agents, trucks, bicycles, or other systems that operate on roadways by allowing them to make judgments about the future behavior of road users based on their state of mind.

The machine learning based model may be any type of supervised learning algorithm capable of predicting a continuous label for a two or three dimensional input, including but not limited to a random forest regressor, a support vector regressor, a simple neural network, a deep convolutional neural network, a recurrent neural network, a long-short-term memory (LSTM) neural network with linear or nonlinear kernels that are two dimensional or three dimensional.

In one embodiment of the model training system 112, the machine learning based model can be a deep neural network. In this embodiment the parameters are the weights attached to the connections between the artificial neurons comprising the network. Pixel data from an image in a training set collated with human observer summary statistics serves as an input to the network. This input can be transformed according to a mathematical function by each of the artificial neurons, and then the transformed information can be transmitted from that artificial neuron to other artificial neurons in the neural network. The transmission between the first artificial neuron and the subsequent neurons can be modified by the weight parameters discussed above. In this embodiment, the neural network can be organized hierarchically such that the value of each input pixel can be transformed by independent layers (e.g., 10 to 20 layers) of artificial neurons, where the inputs for neurons at a given layer come from the previous layer, and all of the outputs for a neuron (and their associated weight parameters) go to the subsequent layer. At the end of the sequence of layers, in this embodiment, the network can produce numbers that are intended to match the human summary statistics given at the input. The difference between the numbers that the network output and the human summary statistics provided at the input comprises an error signal. An algorithm (e.g., back-propagation) can be used to assign a small portion of the responsibility for the error to each of the weight parameters in the network. The weight parameters can then be adjusted such that their estimated contribution to the overall error is reduced. This process can be repeated for each image (or for each combination of pixel data and human observer summary statistics) in the training set. At the end of this process the model is “trained”, which in some embodiments, means that the difference between the summary statistics output by the neural network and the summary statistics calculated from the responses of the human observers is minimized.

According to an embodiment, a vehicle computing system 120 executes the trained machine learning based model to predict hidden context representing intentions and future plans of a traffic entity (e.g., a pedestrian or a bicyclist). The hidden context may represent a state of mind of a person represented by the traffic entity. For example, the hidden context may represent a near term goal of the person represented by the traffic entity, for example, indicating that the person is likely to cross the street, or indicating that the person is likely to pick up an object (e.g., a wallet) dropped on the street but stay on that side of the street, or any other task that the person is likely to perform within a threshold time interval. The hidden context may represent a degree of awareness of the person about the autonomous vehicle, for example, whether a bicyclist driving in front of the autonomous vehicle is likely to be aware that the autonomous vehicle is behind the bicycle.

The hidden context may be used for navigating the autonomous vehicle, for example, by adjusting the path planning of the autonomous vehicle based on the hidden context. The vehicle computing system 120 may improve the path planning by taking a machine learning based model that predicts the hidden context representing a level of human uncertainty about the future actions of pedestrians and cyclists and uses that as an input into the autonomous vehicle's motion planner. The training dataset of the machine learning models includes information about the ground truth of the world obtained from one or more computer vision models. The vehicle computing system 120 may use the output of the prediction engine 114 to generate a probabilistic map of the risk of encountering an obstacle given different possible motion vectors at the next time step. Alternatively, the vehicle computing system 120 may use the output of the prediction engine 114 to determine a motion plan which incorporates the probabilistic uncertainty of the human assessment.

In an embodiment, the prediction engine 114 determines a metric representing a degree of uncertainty in human assessment of the near-term goal of a pedestrian or any user representing a traffic entity. The specific form of the representation of uncertainty is a model output that is in the form of a probability distribution, capturing the expected distributional characteristics of user responses of the hidden context of traffic entities responsive to the users being presented with videos/images representing traffic situations. The model output may comprise summary statistics of hidden context, i.e., the central tendency representing the mean likelihood that a person will act in a certain way and one or more parameters including the variance, kurtosis, skew, heteroskedasticity, and multimodality of the predicted human distribution. These summary statistics represent information about the level of human uncertainty.

In an embodiment, the vehicle computing system 120 represents the hidden context as a vector of values, each value representing a parameter, for example, a likelihood that a person represented by a traffic entity is going to cross the street in front of the autonomous vehicle, a degree of awareness of the presence of autonomous vehicle in the mind of a person represented by a traffic entity, and so on.

### Scenario Based Driving Recommendations

A system navigates an autonomous vehicle driving through traffic on a road. The system accesses a machine learning based model trained to receive an input video frame showing a traffic entity and output a score describing a traffic entity in the input video frame. The system stores a mapping from ranges of values of the score to driving recommendations for each of a plurality of traffic scenarios. Each driving recommendation for a traffic scenario is determined based on annotations provided by users presented with a video frame representing the traffic scenario.

The system receives a particular video frame captured by a camera mounted on an autonomous vehicle at a particular time while driving. identifying a particular traffic scenario corresponding to the particular video frame. The system accesses the mapping from the ranges of values of the score to driving recommendations corresponding to the particular traffic scenario. The system applies the machine learning based model to the particular video frame to output a score describing a traffic entity in the particular video frame. The system identifies a range of score corresponding to the score describing the traffic entity in the particular video frame that was output by the machine learning based model. The system determines a driving recommendation for the autonomous vehicle corresponding to the identified range of score. The system sends signals to controls of the autonomous vehicle to navigate the autonomous vehicle according to the driving recommendation.

According to an embodiment, a traffic scenario is associated with filtering criteria based on one or more attributes associated with the autonomous vehicle at the particular time the particular video frame was captured. The filtering criteria may be based on information including one or more vehicle attributes describing movement of the autonomous vehicle, one or more traffic attributes describing actions of one or more traffic entities; or one or more road attributes describing a configuration of the road.

According to an embodiment, an attribute used in the filtering criteria for the particular traffic scenario describes a movement of the autonomous vehicle when the video frame was captured by the camera mounted on the autonomous vehicle. As another example, the attribute describing the movement of the autonomous vehicle represents a direction in which the autonomous vehicle was planning on turning when the video frame was captured by the camera mounted on the autonomous vehicle. The attribute describing the movement of the autonomous vehicle is extracted form one or more equipment of the autonomous vehicle comprising: on-board diagnostics (OBD), inertial measurement unit (IM), or global navigation satellite system (GNSS). The attribute describing the movement of the autonomous vehicle may represent a speed at which the autonomous vehicle is driving

According to an embodiment, an attribute used in the filtering criteria for the particular traffic scenario describes a traffic entity displayed in the video frame. The attribute describing the traffic entity displayed in the video frame represents a state of mind of the traffic entity. The attribute describing the traffic entity displayed in the video frame represents a position of the traffic entity with respect to the road.

According to an embodiment, the autonomous vehicle was at a location on the road when the video frame was captured by the camera mounted on the autonomous vehicle and an attribute used in the filtering criteria for the particular traffic scenario describes a configuration of the road near the location. For example, the attribute describing the configuration of the road is determined based on one or more of: determining a location of the autonomous vehicle based on a navigation system compared with a map; or performing object recognition on the video frame to detect a traffic sign in the video frame. The attribute describing the configuration of the road represents whether one or more of following is approaching as the autonomous vehicle drives on the road: a traffic intersection, a cross walk, or a traffic sign that causes a speed of the autonomous vehicle to change.

According to an embodiment, a driving recommendation for a traffic scenario is determines as follows. A video frame representing the traffic scenarios presented to a plurality of users along with information describing a set of possible driving recommendations. Annotations indicating the driving recommendation according for the video frame are received from each of the plurality of users. The driving recommendation for the traffic scenario is determined as an aggregate value based on the annotations received from the plurality of users.

Embodiments include methods for these processes, non-transitory computer readable storage media storing instructions that when executed by one or more computer processors, cause the one or more computer processors to perform steps of these methods, and computer systems including one or more computer processors and non-transitory computer readable storage media storing instructions that when executed by the one or more computer processors, cause the one or more computer processors to perform steps of these methods.

FIG. 4A illustrates the data structures for making driving recommendations for various traffic scenarios, according to some embodiments of the invention. FIG. 4B shows a mapping from state of mind signals to driving recommendations, according to some embodiments of the invention.

The system stores metadata associated with various traffic scenarios. The system stores various threshold values for each traffic scenario type.

Each threshold is associated with a type of SOMAI signal. Any reference to a threshold of SOMAI signals herein includes combinations and or transformations thereof. The thresholds may represent various ranges of values for the SOMAI signal such that a range of value is associated with a particular driving recommendation. For example, threshold values T11, T12, T13, and T14 are associated with scenario S1, threshold values T21, T22, T23, and T24 are associated with scenario S2, and threshold values T31, T32, T33, and T34 are associated with scenario S3, and so on. The system generates driving recommendations by comparing SOMAI signals generated by the system based on sensor data describing the traffic while driving a vehicle with the threshold values. The threshold values may represent ranges of SOMAI signals such that if the generated SOMAI signal value falls within a range defined by one or more thresholds, the system generates a driving recommendation corresponding to that range as defined by the mapping shown in FIG. 4. In an embodiment, the system generates multiple SOMAI signals. The system maps combinations of ranges of the plurality of SOMAI signals to driving recommendations. For example, if the system generates SOMAI signals SIGNAL1 and SIGNAL2, the system may map a combination of range R11 of SIGNAL1 and range R21 of SIGNAL2 to a driving recommendation D1, a combination of range R12 of SIGNAL1 and range R21 of SIGNAL2 to a driving recommendation D2, a combination of range R11 of SIGNAL1 and range R22 of SIGNAL2 to a driving recommendation D3, a combination of range R12 of SIGNAL1 and range R22 of SIGNAL2 to a driving recommendation D4 and so on.

In some embodiments, the system stores multiple mappings from thresholds to driving recommendations. Each mapping corresponds to a type of driving behavior. For example, a mapping M1 may represent highly conservative behavior, a mapping M2 may represent aggressive behavior, and a mapping M3 may represent a moderate behavior that is neither very conservative not very aggressive. In an embodiment, a system administrator picks the type of driving behavior based on various factors, for example, a degree of confidence in the AV stack, a location in which the AV is driving and so on. In other embodiments, the system automatically determines the AV behavior based on measures of above factors or in combination with additional contextual information. For example, the system stores associations between regions and type of driving behavior. The system determines the current region of the AV based on the AV's location and selects the driving behavior for the region. In another embodiment, the confidence in the AV stack is determined based on various performance tests and evaluations performed. If the performance tests and evaluations indicate a high degree of confidence in the AV stack, the system selects more aggressive driving behavior and if the performance tests and evaluations indicate a high degree of confidence in the AV stack, the system selects more conservative driving behavior.

In an embodiment, the system generates multiple SOMAI signals, for example, SOMAI signal 410a shown in FIG. 4B represents a particular intent of a traffic entity such as the intent of a pedestrian to enter a crosswalk or the intent of a pedestrian to walk in front of the vehicle; SOMAI signal 410b shown in FIG. 4B represents a measure of awareness of the vehicle in the mind of the pedestrian or bicyclist. The system identifies ranges of values of each SOMAI signal, for example, ranges 420a of SOMAI signal 410a and ranges 420b of SOMAI signal 410b. The system maps each combination of ranges of the plurality of SOMAI signal to a driving recommendation 430. Accordingly, the start and end values of a SOMAI signal for a range act as thresholds and when the SOMAI signal generated by the system based on data describing traffic has values within the thresholds corresponding to a range, the system generates the corresponding driving recommendation as shown in FIG. 4.

FIG. 4C shows an example user interface presented to expert annotators to receive their driving recommendations, according to some embodiments of the invention. As shown in the example user interface, the expert annotator is presented with a plurality of options representing various actions that a driver can take when faced with a particular traffic scenario. The expert annotator selects one of the options. The selected option is received by the system. The system receives such options for the same traffic scenario from multiple expert annotators and selects the ideal driving recommendations based on an aggregate driving recommendation, for example, the driving recommendation that was made by the majority of expert annotators.

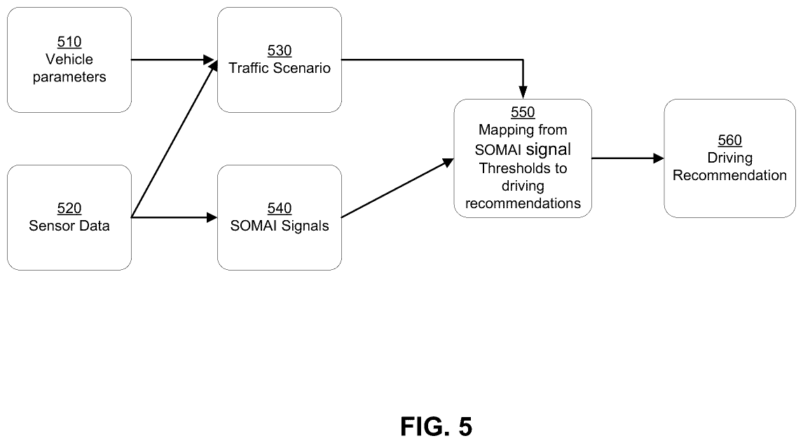

FIG. 5 illustrates the flow of data for making driving recommendations, according to some embodiments of the invention. The system receives vehicle parameters 510 including the vehicle location, vehicle speed, whether the vehicle is planning on making a turn and the direction of the turn, and so on. The system also receives the sensor data 520 captured by the vehicle. The sensor data describes the traffic as well as provides information about the road, for example, whether there is a crosswalk (or sidewalk), whether there is a pedestrian, a position of the pedestrian with respect to the crosswalk (or sidewalk), a speed with which the pedestrian is moving, and so on. The system uses the various parameters describing the vehicle and information describing the traffic extracted from the sensor data to identify a particular traffic scenario 530 that matches the vehicle parameters and the traffic information. The system further processes the sensor data, for example, using the prediction engine 114 to generate one or more SOMAI signals 540. The system may generate a set of SOMAI signals for each of one or more traffic entities that are identified based on the sensor data. The system uses the identified traffic scenario 530 to determine a mapping 550 from a set of SOMAI signal thresholds to driving recommendations, for example, as shown in FIG. 4. The system uses the mapping 550 to determine a driving recommendation 560 for the generated SOMAI signals 540.

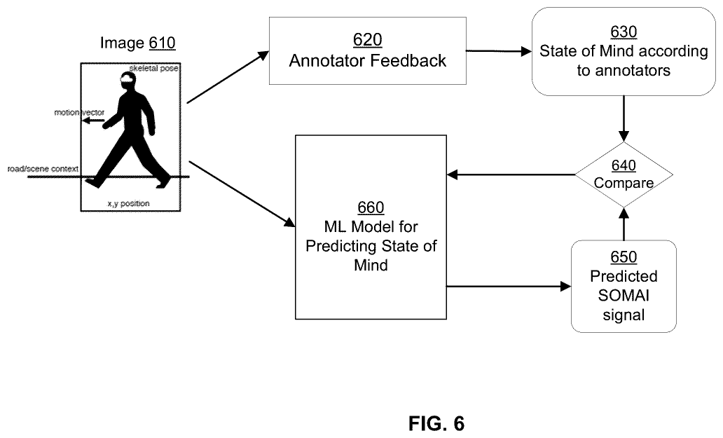

FIG. 6 illustrates the process for evaluating a machine learning based model used by an autonomous vehicle, according to some embodiments of the invention. The system receives sensor data captured by sensors of the vehicle, for example, an image 610 captured by cameras mounted on an autonomous vehicle or a video captured by the cameras. The system provides the image 610 (or the video) to expert annotators to receive annotator feedback 620 describing the SOMAI signal values according to the expert annotators. The feedback describes the state of mind of a traffic entity, for example, a pedestrian or bicyclist. The system uses the annotator feedback to evaluate components of the AV, for example, the machine learning based model 660 for predicting particular SOMAI signals. The system provides the image 610 to the machine learning based model 660 to predict the SOMAI signal 650. The system compares 640 the predicted SOMAI signal with the value 630 of the SOMAI signal as determined by the expert annotators. The comparison 640 may be used during a training process to adjust the parameters of the machine learning based model 660. The comparison 640 may be used during a model evaluation process to evaluate the machine learning based model 660. For example, if the comparison 640 indicates that the SOMAI signal value 630 according to the annotators is more than a threshold different compared to the predicted SOMAI signal 650, the machine learning based model 660 is not accurate enough and may need further training. The process described in FIG. 6 evaluates the machine learning based model 660. Furthermore, the true state of mind of a traffic entity, for example, a pedestrian may not be determined from the image 610. The annotator feedback is only an approximate guess that seems most appropriate to a majority of annotators. It is likely that the annotators may not have correctly guessed the state of mind of a pedestrian and there is no way to verify what the state of the mind of the pedestrian was at that point in time when the image 610 was captured. Accordingly, there is no accurate mechanism to establish a ground truth representing the absolutely correct values of the state of mind of a pedestrian or bicyclist for evaluating the machine learning based model 660.

According to an embodiment, the system uses driving recommendations for a traffic scenario as a proxy for evaluating machine learning based model 660 or any other component within an AV stack. The AV stack represents a set of components of an AV (autonomous vehicle) that interact with each other to navigate the AV through traffic. For example, a component may receive sensor data, the component may generate some output that is provided as input to another component, and so on. The components interact with each other to make a driving decision, for example, to determine a driving action to be taken when encountered with a traffic scenario. The components of the AV stack further provide the appropriate control signals to the controls of the AV to implement the driving action that was identified.

The driving recommendations act as ground truth since reasonable drivers are likely to make the same driving recommendation for a given traffic scenario. Furthermore, the accuracy of driving recommendations can be verified, for example, by analyzing historical data. The system analyzes historical data comprising sensor data and the vehicle parameters stored during a trip made by the vehicle. The system identifies a particular traffic scenario based on a video frame V1 and checks the video frames V2, V3, V4, etc. that occur after the video frame V1 to confirm whether the vehicle drove according to the driving recommendation that was predicted. If the vehicle is driven by a human driver, the system verifies the deviation of the predicted driving recommendation from the actual action taken by the human driver for each traffic scenario encountered along the ride.

### Evaluation of Components of an Autonomous Vehicle

The system according to various embodiments evaluates components of an autonomous vehicle, for example, machine learning models used by an autonomous vehicle including the ML models to predict state of mind of traffic entities described herein. The components of the autonomous vehicles may be organized as an AV stack, say AV1. The system receives driving recommendations for a set of traffic scenarios determined based on user annotations of video frames showing each traffic scenario. For each of the set of traffic scenarios, the system predicts driving recommendations made using the autonomous vehicle stack of components, compares predicted driving recommendations made using the autonomous vehicle stack against the received driving recommendations, and determines a measure M1 of quality of driving recommendation based on the comparison. The system receives a modified component of the autonomous vehicle stack, for example, a new version of a component or a machine learning model that has been trained further using new training data. This results in a modified AV stack, say AV2. For each of the set of traffic scenarios, the system predicts driving recommendations made using the modified autonomous vehicle stack of components, compares predicted driving recommendations made using the modified autonomous vehicle stack against the received driving recommendations, and determines a measure M2 of quality of driving recommendation based on the comparison. The system evaluates the modification of the component of the autonomous vehicle stack based on a comparison of the measure M1 of quality of driving recommendation and the measure M2 of quality of driving recommendation. For example, if the comparison of M1 and M2 indicates quality of driving recommendations based on the modified stack has degraded, the system may determine that the modifications to the component should be rejected or provided to an expert or a developer for further investigation. On the other hand, if the comparison of M1 and M2 indicates quality of driving recommendations based on the modified stack has improved, the system may determine that the modifications to the component should be accepted and the modified AV stack AV2 approved for further use.

According to an embodiment, the measures M1 and M2 of quality of driving recommendation the components are determined based on a percentage of scenarios for which the predicted driving recommendations fail to match the received driving recommendations. For example, M1>M2 (i.e., M1 indicates higher quality compared to M2) if the percentage of scenarios for which the predicted driving recommendations fail to match the received driving recommendations for AV1 is less than the percentage of scenarios for which the predicted driving recommendations fail to match the received driving recommendations for AV2.

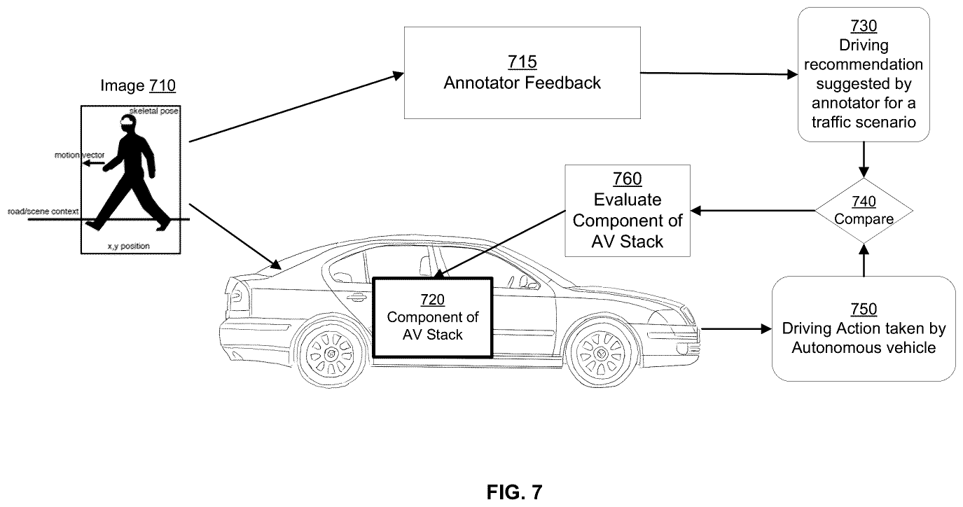

FIG. 7 shows the data flow of a process for evaluating a component of an autonomous vehicle, according to some embodiments of the invention. The system receives sensor data, for example, the image 710 or a video frame or a video. The system provides the video frame to annotators, for example, via a user interface as shown in FIG. 4C. The system receives annotator feedback 715 describing a driving recommendation 730 for the traffic scenario represented by the image 710. The driving recommendation 730 represents a driving action that is suggested by the annotator for the traffic scenario represented by the image 710.

When a vehicle is driving, the system captures the sensor data, for example, the image 710. The image 710 is provided to one or more components 720 of the AV stack, for example, the components of the stack may include the machine learning based model that predicts a SOMAI signal. The components of the AV stack determine 750 a driving action taken by the autonomous vehicle. The system compares 740 the driving action taken by the autonomous vehicle with the driving recommendation suggested by the annotators for the traffic scenario represented by the image 710. The system evaluates 760 one or more components 720 of the AV stack based on the comparison 740. For example, if the driving action taken by the AV matches the driving recommendations of the annotators, the system determines that the component 720 is performing well. For example, if the component 720 is being evaluated for being deployed in production, the evaluation may recommend that the component is ready for production. In contrast if the driving action taken by the AV fails to match the driving recommendations of the annotators, the system determines that the component 720 is not performing as expected. For example, if the component 720 is being evaluated for being deployed in production, the evaluation may recommend that the component is not ready for production and needs further improvements or adjustments. For example, if the component 720 is a machine learning based model that generates SOMAI signals, the system may recommend that the machine learning based model needs further training.

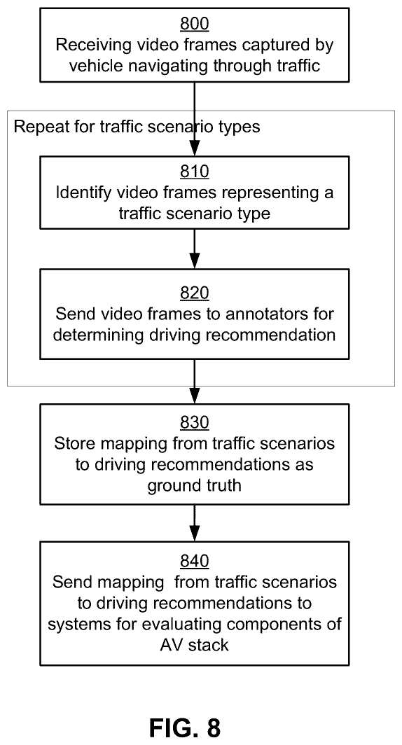

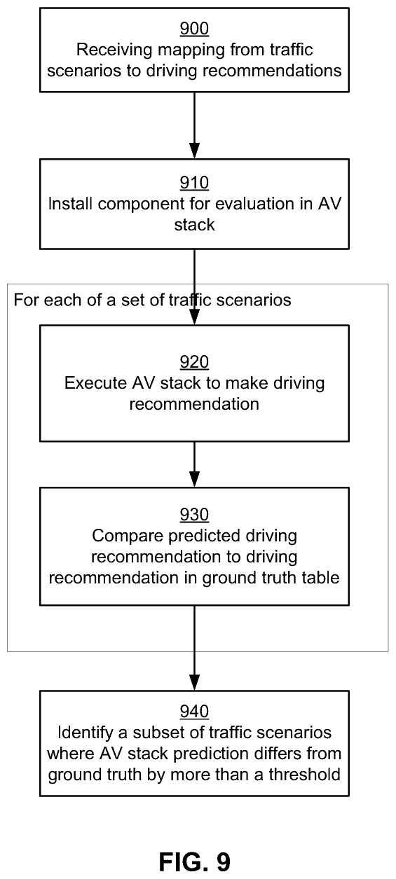

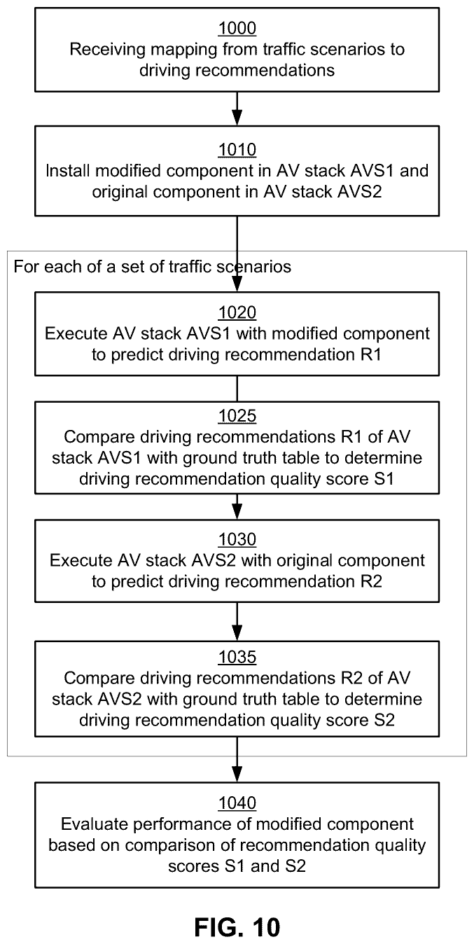

FIG. 8 is a flowchart generating driving recommendations for use as ground truth for component evaluation, according to some embodiments of the invention. The system receives 800 video frames captured by vehicles navigating through traffic. The system repeats the steps 810 and 820 for each scenario type. The system identifies 810 video frames representing the traffic scenario. The system sends 820 the video frames to annotators for providing driving recommendations based on the video frame. For example, the system may present the video frame using a user interface similar to that shown in FIG. 4C. The system accordingly receives driving recommendations for various traffic scenarios. The system stores 830 mappings from various traffic scenarios to driving recommendations as ground truth. The system sends 840 the ground truth information comprising mappings from traffic scenarios to driving recommendations to systems for evaluating components of AV stacks as shown in FIG. 9 and FIG. 10. The mapping is also referred to herein as the ground truth table.

FIG. 9 is a flowchart of a process for using driving recommendations for evaluating components of an autonomous vehicle, according to some embodiments of the invention. The system receives 900 a mapping from traffic scenarios to driving recommendations that may be determined using the process of FIG. 8. The system uses the mapping to evaluate an AV stack, for example, an AV stack in which a particular component is installed 910 to determine an impact of adding the particular component. An example of the particular component is a machine learning based model that generates a particular SOMAI signal to determine an impact of using the particular SOMAI signal on driving of the autonomous vehicle. The system executes the steps 920 and 930 for each of a set of traffic scenarios. The system executes 920 the AV stack for video frames corresponding to the traffic scenario so as to predict a driving recommendation. The system compares 930 the predicted driving recommendation to the driving recommendation for the traffic scenario as determined from the mapping representing the ground truth table. The system identifies 940 based on the comparison, a subset of traffic scenarios where the driving recommendation predicted by the AV stack differs by more than a threshold with the driving recommendation determined from the ground truth table. The difference between the predicted driving recommendations and the ground truth driving recommendations may be measured as the percentage of input video frames for which the predicted driving recommendation differs from the ground truth driving recommendation. This allows the system to evaluate the AV stack for various traffic scenarios. The system may report the traffic scenarios for which the AV stack does not perform well. For example, if the AV stack includes a machine learning based model that generates a SOMAI signal, the system may train the machine learning based model using training data based on the identified subset of traffic scenarios. This allows the system to improve efficiency of developing a component, for example, efficiency of training a machine learning based model by focusing on specific traffic scenarios that need improvement rather than retraining the machine learning based model for all traffic scenarios. In an embodiment, the system uses the process of FIG. 9 to compare performance of an AV stack that does not use a particular component with the performance of an AV stack that does include the particular component to identify traffic scenarios where the particular component improves performance as well as traffic scenario where the component degrades the performance.

FIG. 10 is a flowchart of a process for using driving recommendations as ground truth for evaluating modifications to components of an autonomous vehicle, according to some embodiments of the invention. The system receives 1000 the ground truth table representing a mapping from traffic scenarios to driving recommendations. The system modifies 1010 the AV stack, for example, by installing a modified component. Accordingly, the AV stack AVS1 includes the modified component and the AV stack AVS2 includes the original component.

The system repeats the steps 1020, 1025, 1030, 1035, for each of a set of traffic scenarios. The system executes 1020 the AV stack AVS1 to predict driving recommendation R1. The system compares 1025 the driving recommendation R1 of the AV stack AVS1 with the driving recommendation of the ground truth table. The system determines a driving recommendation quality score S1 for the AV stack AVS1. The system executes 1030 the AV stack AVS2 to predict driving recommendation R2. The system compares 1035 the driving recommendation R2 of the AV stack AVS1 with the driving recommendation of the ground truth table. The system determines a driving recommendation quality score S2 for the AV stack AVS2.

The system evaluates 1040 the performance of the modified component based on the comparison of the recommendation quality score S1 and S2. The system may identify traffic scenarios where the modified component performs better than the original component as well as traffic scenarios where the modified component performs worse than the original component.

### Training Machine Learning Models for Predicting State of Mind of Traffic Entities

A system evaluates machine learning based models used for navigation of autonomous vehicles. The system sends a set V1 of video frames to a set U1 of users. Each video frame showing a traffic scenario includes one or more traffic entities, for example, pedestrians, bicyclists, and so on. The system receives a set A1 of annotations based on video frames of the set V1 of video frames. Each annotation of the set A1 of annotations is for a video frame from the set V1 of video frames and describes a state of mind of a traffic entity shown in the video frame. The system trains a machine learning based model using the set A1 of annotations of the first set of video frames. The machine learning based model is configured to receive an input video frame and predict a state of mind of a traffic entity displayed in the video frame. The system sends a set V2 of video frames to a set U2 of users. Each video frame shows a traffic scenario including one or more traffic entities. The system receives a second set A2 of annotations based on video frames of the set V2 of video frames. Each annotation is for a video frame from the set V2 of video frames and describes a driving recommendation for the traffic scenario shown in the video frame being annotated. The system determines a measure of driving quality of an autonomous vehicle based on a comparison of driving actions determined based on predictions of the machine learning based model and driving recommendations received from annotators. The system identifies additional training data for training the machine learning based model based on the measure of driving quality and trains the machine learning based model based on the additional training data. The set V1 of video frames may be identical to the set V2 of video frames or the two sets V1 and V2 may overlap or the two sets V1 and V2 may be completely distinct. Similarly the set U1 of users may be identical to the set U2 of users or the two sets U1 and U2 may overlap or the two sets U1 and U2 may be completely distinct.

According to an embodiment, the system trains the machine learning based model by generating statistical information describing the set A1 of annotations and training the machine learning based model based on the set V1 of video frames and corresponding statistical information. The machine learning based model predicts statistical information describing state of mind of a traffic entity shown in an input video frame.

According to an embodiment, the system determines the measure of driving quality for each of a plurality of traffic scenarios and identifies one or more traffic scenarios having the measure of driving quality below a threshold value. The additional training data corresponds to the identified traffic scenarios.

According to an embodiment, a particular traffic scenario corresponding to a video frame is associated with a filtering criteria based on one or more attributes associated with the autonomous vehicle when the video frame was captured. An attribute used in the filtering criteria for the particular traffic scenario may describe a movement of the autonomous vehicle when the video frame was captured by a camera mounted on the autonomous vehicle. An attribute used in the filtering criteria for the particular traffic scenario may describe a traffic entity displayed in the video frame. According to an embodiment, the autonomous vehicle was at a location on a road when the video frame was captured by a camera mounted on the autonomous vehicle, and an attribute used in the filtering criteria for the particular traffic scenario describes a configuration of the road near the location, for example, whether the autonomous vehicle was approaching an intersection, a cross walk, a particular road sign, and so on.

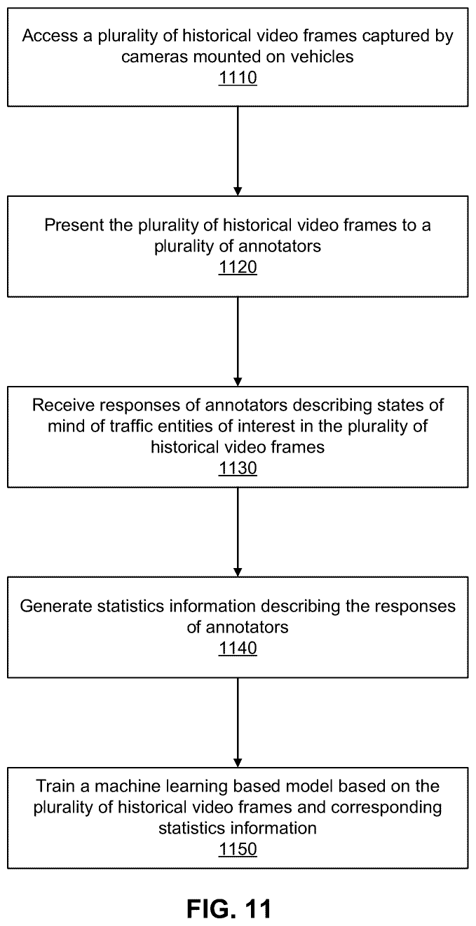

FIG. 11 is a flowchart showing a process of training a machine learning based model using summary statistics, according to some embodiments. The model training system accesses 1110 a plurality of historical video frames captured by cameras mounted on vehicles. The plurality of historical video frames are selected to cover a variety of scenarios that vehicles may encounter while traveling. The historical video frames may be modified to identify traffic entities (e.g., a particular pedestrian, a particular bicyclist) of interest. The historical video frames are presented 1120 to a plurality of annotators. The plurality of annotators are asked to answer one or more questions on the states of mind of the traffic entities of interest such as “how likely is the highlighted person to cross in front of the vehicle?”, “how likely is the highlighted person to wait at the corner of the street?”, or “how aware is the highlighted person of the vehicle.” The model training system receives 1130 responses of annotators describing states of mind of traffic entities of interest in the plurality of historical video frames and generates 1140 statistics information describing the responses of annotators. Based on the plurality of historical video frames and corresponding statistics information, the model training system trains 1150 a machine learning based model. The model training system iteratively applies the historical video frames to the machine learning based model and compares the outputs to the statistics information of annotator responses and adjusts model parameters using backpropagation.

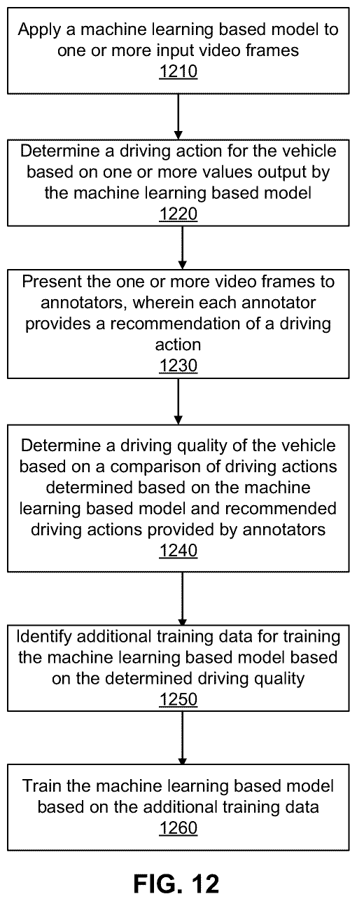

FIG. 12 is a flowchart showing a process of evaluating the machine learning based models for predicting the state of mind of road users using a trained learning algorithm, according to some embodiments. A machine learning based model is applied 1210 to one or more input video frames captured by one or more cameras coupled to a vehicle. The machine learning based model is trained using training data to receive the one or more video frames as input and output one or more values associated with attributes describing a state of mind of a traffic entity of interest in the one or more video frames. That is, the machine learning based model predicts how a traffic entity is likely to behave based on the video frames. Using one or more values output by the machine learning based model for the one or more input video frames, a driving action for the vehicle that captured the video frame is determined 1220. The same one or more video frames are presented 1230 to annotators, and each annotator provides a recommendation of a driving action. A driving quality of the vehicle 1240 is determined by comparing driving actions determined based on the machine learning based model and recommended driving actions provided by annotators. The comparison can be used to identify scenarios where the model-based driving actions deviate from annotator recommended driving actions. Additional training data for these “weak scenarios” is identified 1250 to further train 1260 the machine learning based model to cause the vehicle to behave more similar to human drivers.

### Process of Navigating an Autonomous Vehicle Through Traffic

According to an embodiment, the system navigates the autonomous vehicle based on hidden context. The vehicle computing system 120 receives sensor data from sensors of the autonomous vehicle. For example, the vehicle computing system 120 may receive lidar scans from lidars and camera images from cameras mounted on the autonomous vehicle. If there are multiple cameras mounted on the vehicle, the vehicle computing system 120 receives videos or images captured by each of the cameras. In an embodiment, the vehicle computing system 120 builds a point cloud representation of the surroundings of the autonomous vehicle based on the sensor data. The point cloud representation includes coordinates of points surrounding the vehicle, for example, three dimensional points and parameters describing each point, for example, the color, intensity, and so on.

The vehicle computing system 120 identifies one or more traffic entities based on the sensor data, for example, pedestrians, bicyclists, or other vehicles driving in the traffic. The traffic entities represent non-stationary objects in the surroundings of the autonomous vehicle.

In an embodiment, the autonomous vehicle obtains a map of the region through which the autonomous vehicle is driving. The autonomous vehicle may obtain the map from a server. The map may include a point cloud representation of the region around the autonomous vehicle. The autonomous vehicle performs localization to determine the location of the autonomous vehicle in the map and accordingly determines the stationary objects in the point cloud surrounding the autonomous vehicle. The autonomous vehicle may superimpose representations of traffic entities on the point cloud representation generated.

The vehicle computing system 120 repeats the following steps and for each identified traffic entity. The vehicle computing system 120 provides the sensor data as input to the ML model and executes the ML model. The vehicle computing system 120 determines a hidden context associated with the traffic entity using the ML model, for example, the intent of a pedestrian.

The vehicle computing system 120 navigates the autonomous vehicle based on the hidden context. For example, the vehicle computing system 120 may determine a safe distance from the traffic entity that the autonomous vehicle should maintain based on the predicted intent of the traffic entity.

### Computing Machine Architecture

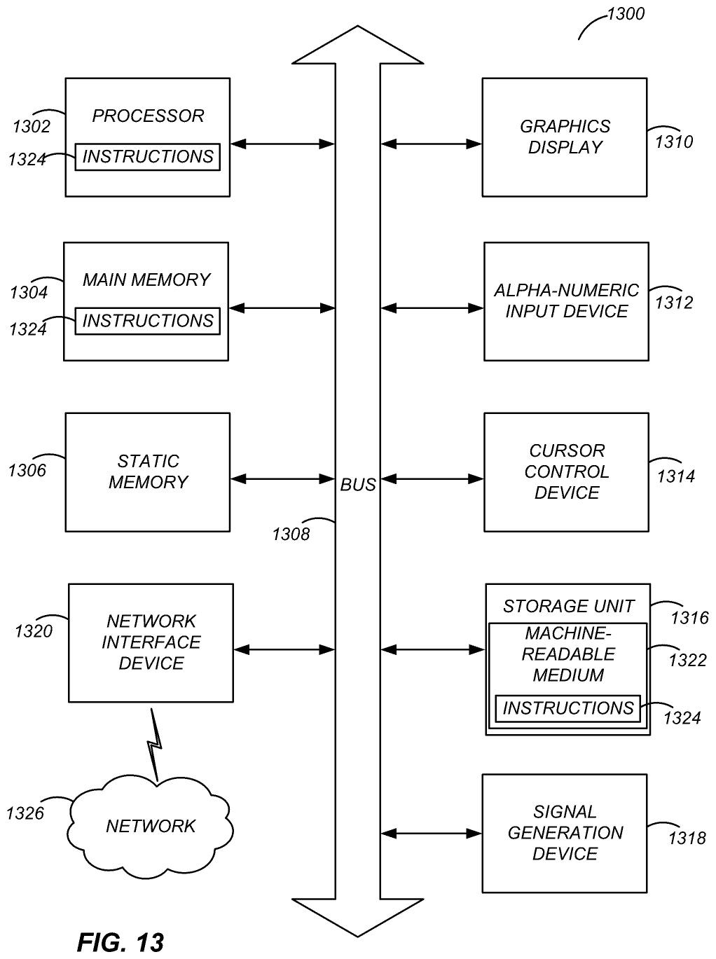

FIG. 13 is a block diagram illustrating components of an example machine able to read instructions from a machine-readable medium and execute them in a processor (or controller). Specifically, FIG. 13 shows a diagrammatic representation of a machine in the example form of a computer system 1300 within which instructions 1324 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1324 (sequential or otherwise) that specify actions to be taken by that machine. Further, while only a single machine is illustrated, the term “machine” shall also be taken to include any collection of machines that individually or jointly execute instructions 1324 to perform any one or more of the methodologies discussed herein.

The example computer system 1300 includes a processor 1302 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1304, and a static memory 1306, which are configured to communicate with each other via a bus 1308. The computer system 1300 may further include graphics display unit 1310 (e.g., a plasma display panel (PDP), a liquid crystal display (LCD), a projector, or a cathode ray tube (CRT)). The computer system 1300 may also include alphanumeric input device 1312 (e.g., a keyboard), a cursor control device 1314 (e.g., a mouse, a trackball, a joystick, a motion sensor, or other pointing instrument), a storage unit 1316, a signal generation device 1318 (e.g., a speaker), and a network interface device 1320, which also are configured to communicate via the bus 1308.

The storage unit 1316 includes a machine-readable medium 1322 on which is stored instructions 1324 (e.g., software) embodying any one or more of the methodologies or functions described herein. The instructions 1324 (e.g., software) may also reside, completely or at least partially, within the main memory 1304 or within the processor 1302 (e.g., within a processor's cache memory) during execution thereof by the computer system 1300, the main memory 1304 and the processor 1302 also constituting machine-readable media. The instructions 1324 (e.g., software) may be transmitted or received over a network 1326 via the network interface device 1320.

While machine-readable medium 1322 is shown in an example embodiment to be a single medium, the term “machine-readable medium” should be taken to include a single medium or multiple media (e.g., a centralized or distributed database, or associated caches and servers) able to store instructions (e.g., instructions 1324). The term “machine-readable medium” shall also be taken to include any medium that is capable of storing instructions (e.g., instructions 1324) for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

Although embodiments disclosed describe techniques for navigating autonomous vehicles, the techniques disclosed are applicable to any mobile apparatus, for example, a robot, a delivery vehicle, a drone, and so on.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device) or in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A computer-implemented method for evaluating modifications to components of an autonomous vehicle stack, the method comprising:
receiving driving recommendations for a set of traffic scenarios determined based on user annotations of video frames showing each traffic scenario;
for each of the set of traffic scenarios:
predicting driving recommendations based on the autonomous vehicle stack, and
determining a first measure of quality of driving recommendation by comparing predicted driving recommendations based on the autonomous vehicle stack with the driving recommendations received for the traffic scenario;
receiving a modified component of the autonomous vehicle stack, the modified component corresponding to a component of the autonomous vehicle stack;
for each of the set of traffic scenarios:
predicting driving recommendations based on the autonomous vehicle stack including the modified component, and
determining a second measure of quality of driving recommendation by comparing predicted driving recommendations based on the autonomous vehicle stack including the modified component with the driving recommendations received for the traffic scenario; and
evaluating the modified component based on a comparison of the first measure of quality of driving recommendation and the second measure of quality of driving recommendation.

2. The computer-implemented method of claim 1, wherein each of the first measure of quality of driving recommendation and the second measure of quality of driving recommendation is determined based on a percentage of scenarios for which the predicted driving recommendations fail to match the driving recommendations received.

3. The computer-implemented method of claim 1, wherein the driving recommendations for the set of traffic scenarios are determined using steps comprising:
presenting a video frame representing a traffic scenario to a plurality of users along with information describing a set of possible driving recommendations;
receiving annotations indicating the driving recommendation for the video frame from each of the plurality of users; and
determining the driving recommendation for the traffic scenario as an aggregate value based on the annotations received from the plurality of users.

4. The computer-implemented method of claim 1, wherein the component being modified is a machine learning based model used for making predictions used for navigating autonomous vehicles.

5. The computer-implemented method of claim 4, wherein the machine learning based model is trained to output a score indicating a state of mind of a traffic entity.

6. The computer-implemented method of claim 5, wherein the driving recommendations received for the set of traffic scenarios comprises, for each scenario, mapping from ranges of the score predicted by the machine learning based model to driving recommendations, wherein each range is mapped to a particular driving recommendation.

7. The computer-implemented method of claim 4, wherein the machine learning based model is trained using steps comprising:
accessing a plurality of historical video frames captured by cameras mounted on vehicles, each historical video frame displaying one or more traffic entities;
presenting the plurality of historical video frames to a plurality of annotators, each video frame modified to identify a traffic entity of interest;
receiving responses of annotators describing states of mind of traffic entities of interest in the plurality of historical video frames;
generating statistics information describing the responses of the annotators; and
training the machine learning based model based on the plurality of historical video frames and corresponding statistics information.

8. The computer-implemented method of claim 1, wherein a traffic scenario is characterized by one or more of:
vehicle attributes describing a movement of a vehicle;
traffic attributes describing actions of one or more traffic entities; and
road attributes describing a configuration of a road corresponding to the traffic scenario.

9. A non-transitory computer readable storage medium storing instructions that when executed by one or more computer processors, cause the one or more computer processors to perform steps for evaluating modifications to components of an autonomous vehicle stack, the steps comprising:
receiving driving recommendations for a set of traffic scenarios determined based on user annotations of video frames showing each traffic scenario;
for each of the set of traffic scenarios:
predicting driving recommendations based on the autonomous vehicle stack, and
determining a first measure of quality of driving recommendation by comparing predicted driving recommendations based on the autonomous vehicle stack with the driving recommendations received for the traffic scenario;
receiving a modified component of the autonomous vehicle stack, the modified component corresponding to a component of the autonomous vehicle stack;
for each of the set of traffic scenarios:
predicting driving recommendations based on the autonomous vehicle stack including the modified component, and
determining a second measure of quality of driving recommendation by comparing predicted driving recommendations based on the autonomous vehicle stack including the modified component with the driving recommendations received for the traffic scenario; and
evaluating the modified component based on a comparison of the first measure of quality of driving recommendation and the second measure of quality of driving recommendation.

10. The non-transitory computer readable storage medium of claim 9, wherein each of the first measure of quality of driving recommendation and the second measure of quality of driving recommendation is determined based on a percentage of scenarios for which the predicted driving recommendations fail to match the driving recommendations received.

11. The non-transitory computer readable storage medium of claim 9, wherein the driving recommendations for the set of traffic scenarios are determined using steps comprising:
presenting a video frame representing a traffic scenario to a plurality of users along with information describing a set of possible driving recommendations;
receiving annotations indicating the driving recommendation for the video frame from each of the plurality of users; and
determining the driving recommendation for the traffic scenario as an aggregate value based on the annotations received from the plurality of users.

12. The non-transitory computer readable storage medium of claim 9, wherein the component being modified is a machine learning based model used for making predictions used for navigating autonomous vehicles.

13. The non-transitory computer readable storage medium of claim 12, wherein the machine learning based model is trained to output a score indicating a state of mind of a traffic entity.

14. The non-transitory computer readable storage medium of claim 13, wherein the driving recommendations received for the set of traffic scenarios comprises, for each scenario, mapping from ranges of the score predicted by the machine learning based model to driving recommendations, wherein each range is mapped to a particular driving recommendation.

15. The non-transitory computer readable storage medium of claim 12, wherein the machine learning based model is trained using steps comprising:
accessing a plurality of historical video frames captured by cameras mounted on vehicles, each historical video frame displaying one or more traffic entities;
presenting the plurality of historical video frames to a plurality of annotators, each video frame modified to identify a traffic entity of interest;
receiving responses of annotators describing states of mind of traffic entities of interest in the plurality of historical video frames;
generating statistics information describing the responses of the annotators; and
training the machine learning based model based on the plurality of historical video frames and corresponding statistics information.

16. The non-transitory computer readable storage medium of claim 9, wherein a traffic scenario is characterized by one or more of:
vehicle attributes describing a movement of a vehicle;
traffic attributes describing actions of one or more traffic entities; and
road attributes describing a configuration of a road corresponding to the traffic scenario.

17. A computer system comprising:
a computer processor; and
a non-transitory computer readable storage medium storing instructions that when executed by one or more computer processors, cause the one or more computer processors to perform steps for evaluating modifications to components of an autonomous vehicle stack, the steps comprising:
receiving driving recommendations for a set of traffic scenarios determined based on user annotations of video frames showing each traffic scenario;
for each of the set of traffic scenarios:
predicting driving recommendations based on the autonomous vehicle stack, and
determining a first measure of quality of driving recommendation by comparing predicted driving recommendations based on the autonomous vehicle stack with the driving recommendations received for the traffic scenario;
receiving a modified component of the autonomous vehicle stack, the modified component corresponding to a component of the autonomous vehicle stack;
for each of the set of traffic scenarios:
predicting driving recommendations based on the autonomous vehicle stack including the modified component, and
determining a second measure of quality of driving recommendation by comparing predicted driving recommendations based on the autonomous vehicle stack including the modified component with the driving recommendations received for the traffic scenario; and
evaluating the modified component based on a comparison of the first measure of quality of driving recommendation and the second measure of quality of driving recommendation.

18. The computer system of claim 17, wherein each of the first measure of quality of driving recommendation and the second measure of quality of driving recommendation is determined based on a percentage of scenarios for which the predicted driving recommendations fail to match the driving recommendations received.

19. The computer system of claim 17, wherein the component being modified is a machine learning based model used for making predictions used for navigating autonomous vehicles, wherein the machine learning based model is trained using steps comprising:
accessing a plurality of historical video frames captured by cameras mounted on vehicles, each historical video frame displaying one or more traffic entities;
presenting the plurality of historical video frames to a plurality of annotators, each video frame modified to identify a traffic entity of interest;
receiving responses of annotators describing states of mind of traffic entities of interest in the plurality of historical video frames;
generating statistics information describing the responses of the annotators; and
training the machine learning based model based on the plurality of historical video frames and corresponding statistics information.

20. The computer system of claim 17, wherein a traffic scenario is characterized by one or more of:
vehicle attributes describing a movement of a vehicle;
traffic attributes describing actions of one or more traffic entities; and
road attributes describing a configuration of a road corresponding to the traffic scenario.
